(19) United States
(12) Patent Application Publication
(10) Pub. No.: US 2026/0211099 A1
(43) Pub. Date: Jul. 23, 2026

(54) RADAR DEVICE, RADAR CONTROL METHOD, AND NON-TRANSITORY COMPUTER READABLE MEDIUM

(71) Applicant: DENSO CORPORATION, Kariya-city (JP)

(72) Inventors: Tatsuya ENAMI, Kariya-city (JP); Osamu ISAJI, Kariya-city (JP); Yukou MURASE, Kariya-city (JP)

(21) Appl. No.: 19/572,015

(22) Filed: Mar. 19, 2026

Related U.S. Application Data
(63) Continuation of application No. PCT/JP2024/034552, filed on Sep. 27, 2024.

(30) Foreign Application Priority Data
Oct. 4, 2023 (JP) 2023-173008

(51) Int. Cl. G01S 13/32; G01S 7/35; G01S 13/34

(52) U.S. Cl. CPC G01S 13/325; G01S 7/354; G01S 13/343

(57) ABSTRACT

A radar device includes a transmission antenna, a reception antenna, and at least one of a circuit or a processor with memory storing executable computer program code. The circuit or processor generates multiple types of transmitted signals, each modulated by a respective code, for transmission via the transmission antenna. The reception antenna receives a mixed signal in which the transmitted signals, reflected by a reflector, are combined. The circuit or processor acquires the mixed received signal, decodes it to generate decoded signals corresponding to each code, and selects a suppression algorithm based on a characteristic parameter correlated with algorithm performance. The selected algorithm is used to suppress sidelobe signal components detected in other decoded signals or related signals, in correlation with a target signal component corresponding to a transmitted signal targeted in a specific decoded signal.

### CROSS REFERENCE TO RELATED APPLICATIONS

The present application is a continuation application of International Patent Application No. PCT/JP2024/034552 filed on Sep. 27, 2024, which designated the U.S. and claims the benefit of priority from Japanese Patent Application No. 2023-173008 filed on Oct. 4, 2023. The entire disclosures of all of the above applications are incorporated herein by reference.

### TECHNICAL FIELD

The present disclosure relates to a technology for controlling a radar device.

### BACKGROUND

As a conventional radar, there is a MIMO (Multiple-Input-Multiple-Output) radar that uses a pseudo-random phase modulation method.

### SUMMARY

According to at least one embodiment, a radar device includes a transmission antenna, a reception antenna, and at least one of a circuit or a processor with memory storing executable computer program code. The circuit or processor generates multiple types of transmitted signals, each modulated by a respective code, for transmission via the transmission antenna. The reception antenna receives a mixed signal in which the transmitted signals, reflected by a reflector, are combined. The circuit or processor acquires the mixed received signal, decodes it to generate decoded signals corresponding to each code, and selects a suppression algorithm based on a characteristic parameter correlated with algorithm performance. The selected algorithm may be used to suppress sidelobe signal components detected in other decoded signals or related signals, in correlation with a target signal component corresponding to a transmitted signal targeted in a specific decoded signal.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating an overall configuration of a radar device according to a first embodiment.

FIG. 2 is a block diagram illustrating a functional configuration of a control unit according to the first embodiment.

FIG. 3 is a graph illustrating an example of a transmitted signal according to the first embodiment.

FIG. 4 is a flowchart illustrating a radar control method according to the first embodiment.

FIG. 5 is a schematic diagram illustrating an overview of signal processing for generating a frequency spectrum of a decoded signal from a distance bin signal.

FIG. 6 is a schematic diagram illustrating an overview of sidelobe suppression processing.

FIG. 7 is a diagram illustrating an example of a frequency spectrum for explaining the definition of S/N ratio.

FIG. 8 is a schematic diagram for explaining an example of an algorithm.

FIG. 9 is a schematic diagram for explaining another example of the algorithm.

FIG. 10 is a schematic diagram illustrating a difference between cases where sidelobe signal components are suppressed and cases where they are not suppressed.

### DETAILED DESCRIPTION

To begin with, examples of relevant techniques will be described.

A MIMO radar according to a comparative example uses a pseudo-random phase modulation scheme. This MIMO radar transmits transmitted signals modulated by different CDM (Code Division Multiplexing) codes from each transmission antenna. The MIMO radar generates a decoded signal spectrum for the received signal according to each CDM code, and estimates sidelobe signal components from each decoded signal spectrum. The MIMO radar can obtain a decoded signal spectrum with suppressed sidelobe signal components by subtracting each estimated sidelobe signal component from the decoded signal spectrum corresponding to the target transmission antenna.

Several algorithms have been proposed for a sidelobe signal component suppression process. The performance of each algorithm varies depending on the situation. However, in the comparative example MIMO radar, it is not possible to select the algorithm according to the situation.

In contrast to the comparative example, according to a radar device, a radar control method, and a radar control program of the present disclosure, an algorithm followed by a sidelobe signal component suppression process can be determined according to the situation.

According to one aspect of the present disclosure, a radar device includes a transmission antenna, a reception antenna, and at least one of a circuit or a processor with memory storing executable computer program code. The circuit or processor generates multiple types of transmitted signals, each modulated by a respective code, for transmission via the transmission antenna. The reception antenna receives a mixed signal in which the transmitted signals, reflected by a reflector, are combined. The circuit or processor acquires the mixed received signal, decodes it to generate decoded signals corresponding to each code, and selects a suppression algorithm based on a characteristic parameter correlated with algorithm performance. The selected algorithm is used to suppress sidelobe signal components detected in other decoded signals or related signals, in correlation with a target signal component corresponding to a transmitted signal targeted in a specific decoded signal.

According to this configuration, the algorithm followed by the sidelobe signal component suppression process is selected in accordance with the characteristic parameters on which the performance of each algorithm depends. Since the characteristic parameters pertain to the decoded signal or related signals, the algorithm can be selected according to the reception conditions of the mixed received signal. Accordingly, it becomes possible to determine the algorithm followed by the sidelobe signal component suppression processing according to the situation.

Hereinafter, several embodiments of the present disclosure will be described with reference to the drawings. In the respective embodiments, corresponding components are denoted by the same reference numerals, and redundant descriptions may be omitted. Further, in cases where only a part of a configuration is described in each embodiment, the other parts of the configuration may be applied using the configurations described in the preceding embodiments. Furthermore, in the descriptions of each embodiment, not only the explicitly stated combinations of configurations, but also, unless there is a specific impediment to such combinations, portions of the configurations of multiple embodiments may be partially combined even if not expressly stated.

### First Embodiment

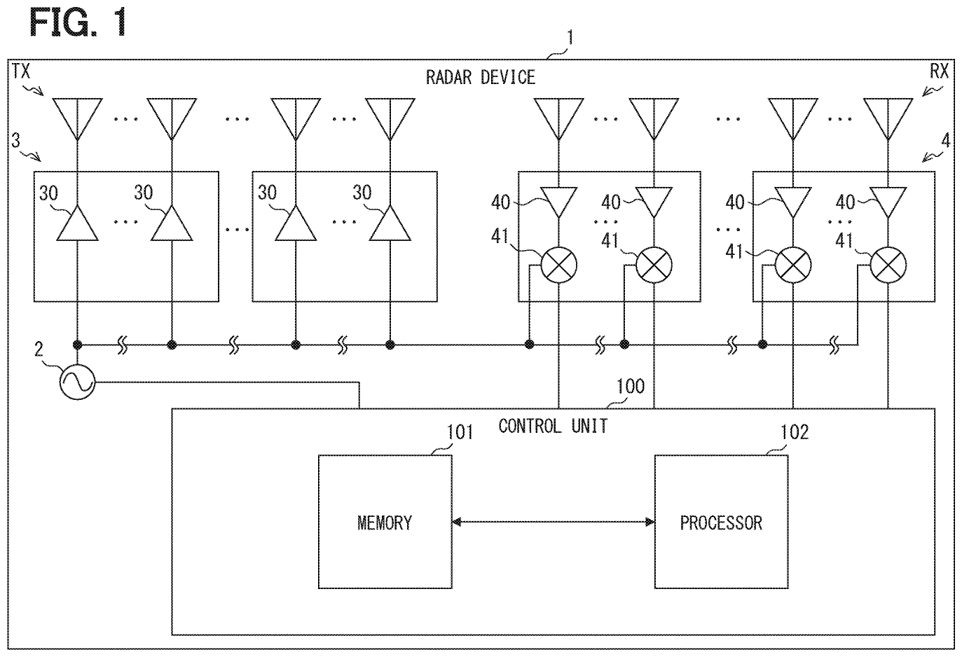

A first embodiment of the present disclosure will be described with reference to FIGS. 1 to 10. A radar device 1 is mounted on a moving object such as a vehicle. The radar device 1 transmits transmitted signals to an external environment, receives as received signals the transmitted signals reflected by objects, and detects, as target information, a distance to a target which is a reflector that has reflected the transmitted signal, a relative velocity with respect to the target, a direction of the target, and the like.

The target information output from the radar device 1 is input to an in-vehicle ECU (electronic control unit) via an in-vehicle network such as a Control Area Network (CAN) (registered trademark) or Ethernet (registered trademark). The in-vehicle ECU executes various processes for automated driving of the vehicle and advanced driving assistance based on the acquired target information of each target.

The processes based on the target information include, for example, collision avoidance processes and warning processes. The collision avoidance process is a process of controlling the vehicle to avoid collision with the target by controlling a brake system and a steering system based on the target information of each target. The warning process is a process for warning a driver of a possibility of a collision with the target based on the target information of each target.

As shown in FIG. 1, the radar device 1 of the present embodiment includes a transmitted signal generation unit 2, transmission circuits 3, transmission antennas TX, reception antennas RX, reception circuits 4, and a control unit 100. The radar device 1 is a so-called MIMO (Multiple-Input-Multiple-Output) radar that transmits transmitted signals from multiple transmission antennas TX to artificially increase the number of reception antennas RX beyond the actual number.

The transmitted signal generation unit 2 acquires a control signal from the control unit 100 and generates a signal modulated in accordance with the control signal. This generated signal is, for example, a so-called chirp signal in which the frequency changes over time (see FIG. 3). The generated signal is distributed to and output to each channel of the transmission circuits 3 and the reception circuits 4. The transmitted signal generation unit 2 outputs, as transmitted signals, generated signals to which pseudo-random phase modulation with different codes is applied for each transmission channel corresponding to each transmission antenna TX. Such a modulation scheme is referred to as code division multiplexing (CDM: Code Division Multiplex). As shown in FIG. 3, in the present embodiment, the transmitted signals transmitted from the different transmission antennas TX are assumed to have substantially the same chirp transmission timing, center frequency, and frequency bandwidth. In FIG. 3, an example of transmitted signals transmitted from two different transmission antennas TX is represented by different line types, namely, a solid line and a dashed line.

That is, in the present embodiment, from each of the transmission antennas TX, transmitted signals to which phase modulation by mutually different codes has been applied are transmitted to the external environment. In addition, among the generated signals, the signal output to the reception circuit 4 with respect to the transmitted signal will hereinafter be referred to as a “local signal.”

The transmission circuits 3 and the reception circuits 4 are each mainly composed of a semiconductor integrated circuit device such as an MMIC (Monolithic Microwave Integrated Circuit). The transmission circuits 3 are connected to the transmission antennas TX and outputs the transmitted signal to the transmission antennas TX. A transmission circuit 3 of the transmission circuits 3 includes amplifiers 30 in the same number as the number of connected transmission antennas TX. The amplifiers 30 amplify the transmitted signal output from the transmitted signal generation unit 2 and output the amplified signals to the corresponding transmission antennas TX.

The transmission antenna TX converts an electrical signal, which is a transmitted signal supplied from the transmitted signal generation unit 2, into a radio wave signal and transmits it to an external environment. In the present embodiment, it is assumed that twelve transmission antennas TX are provided. Hereinafter, when distinguishing each transmission antenna TX individually, it will be denoted as TXn (where “n” is a natural number from 1 to 12). A transmission antenna TX of the transmission antennas TX includes at least one antenna element. For example, the transmission antenna TX is a patch antenna having flat-plate-shaped antenna elements. The antenna element is provided on a dielectric substrate. The dielectric substrate has a surface on which a ground plane is provided and a surface on which the antenna element is provided. The antenna element is provided on the dielectric substrate in a position facing the ground plane. The multiple antenna elements are connected, for example, in series, by a feed line that supplies an electric signal.

A reception antenna RX of the reception antennas RX receives, as a received signal, a radio wave signal including a transmitted signal reflected from a target in the external environment as a reflecting object. Each of the reception antennas RX receives a signal in which the received signals corresponding to the respective transmitted signals from the transmission antennas TX are mixed. Hereinafter, the signal in this mixed state received by each reception antenna RX will be referred to as a “mixed received signal.” Furthermore, the components of each received signal corresponding to each transmitted signal from the transmission antennas TX, which are mixed in the mixed received signal, will be referred to as “received signal components.”

The reception antenna RX converts the received signal, which is a radio wave signal, into an electric signal and outputs it to the corresponding reception circuit 4. The reception antenna RX is, for example, a patch antenna having at least one antenna element connected in series by a feeder line, similar to the transmission antenna TX.

The reception circuit 4 is connected to the reception antenna RX and acquires the received signal received by the reception antenna RX for each reception channel corresponding to each reception antenna RX. The reception circuit 4 includes amplifiers 40 and signal mixing units 41, the number of which is equal to the number of reception antennas RX connected.

An amplifier 40 amplifies the received signal received by the reception antenna and outputs the amplified signal to a signal mixing unit 41. The signal mixing unit 41 generates a beat signal by mixing the local signal from the transmitted signal generation unit 2 with the received signal. The generated beat signal is an interference signal that represents a frequency difference between the received signal and the local signal. The beat signal is output to the control unit 100 after high-frequency components outside the frequency difference between the received signal and the local signal are filtered out by a low-pass filter (not shown).

The control unit 100 is connected to the transmitted signal generation unit 2 and the reception circuit 4 via at least one type of connection, such as a LAN (Local Area Network) line, wiring harness, internal bus, or wireless communication line. The control unit 100 is configured to include at least one dedicated computer.

The dedicated computer constituting the control unit 100 may be a radar ECU (Electronic Control Unit) specialized for controlling a specific radar device 1. The dedicated computer constituting the control unit 100 may also be a radar supervisory ECU that collectively controls multiple radar devices 1 mounted on the moving object. The dedicated computer constituting the control unit 100 may also be a sensor supervisory ECU that collectively controls multiple sensors, including the radar device 1 and other sensors such as LiDAR (Light Detection and Ranging/Laser Imaging Detection and Ranging).

The dedicated computer constituting the control unit 100 includes at least one memory 101 and at least one processor 102. The memory 101 is at least one type of non-transitory tangible storage medium, which non-transitorily stores computer-readable programs and data. Examples of the non transitory tangible storage medium include semiconductor medium, magnetic medium, and optical medium. Here, the storage may refer to storage where data is retained even when the vehicle is turned off, or the storage may refer to temporary storage where data is erased when the vehicle is turned off. The processor 102 includes, as a processing core, at least one type of a Central Processing Unit (CPU), a Graphics Processing Unit (GPU), a Reduced Instruction Set Computer (RISC)-CPU, a Data Flow Processor (DFP), and a Graph Streaming Processor (GSP).

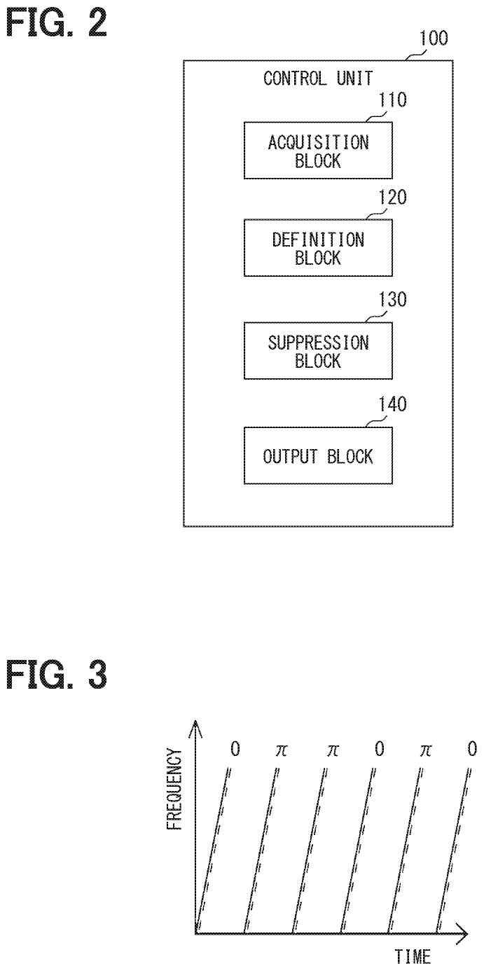

In the control unit 100, the processor 102 executes instructions included in a radar control program stored in the memory 101, which is a storage medium, in order to control the radar device 1. As a result, the control unit 100 constructs functional blocks for controlling the radar device 1. The functional blocks constructed in the control unit 100 include, as shown in FIG. 2, an acquisition block 110, a definition block 120, a suppression block 130, and an output block 140. It should be noted that each of the above functional blocks may also be referred to as functional units, namely, an acquisition unit, a definition unit, a suppression unit, and an output unit, respectively.

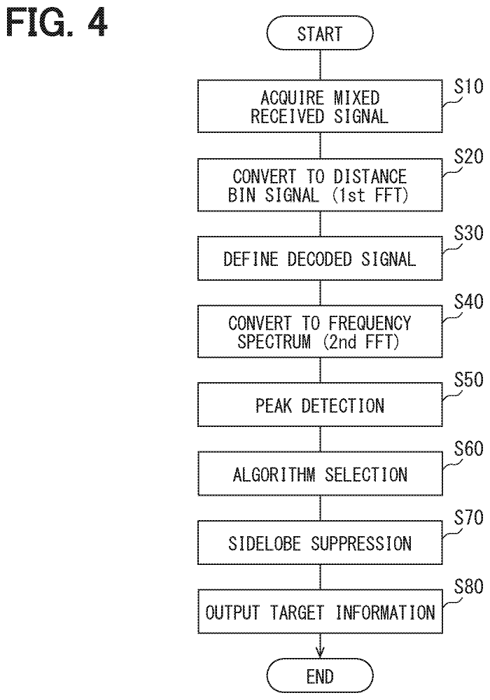

Through the cooperation of these blocks 110, 120, 130, and 140, the radar control method by which the control unit 100 controls the radar device 1 is executed in accordance with the radar control flow shown in FIG. 4. The radar control flow is repeatedly executed while the radar device 1 is operating. This radar control flow is executed, for example, for each reception channel, and one cycle is defined as the process in which all reception channels have been processed once. Here, in the radar control flow, “S” means steps of the process executed by instructions included in the radar control program.

First, in S10, the acquisition block 110 acquires the mixed received signal. The mixed received signal is a beat signal obtained by mixing a local signal from the signal generation unit with a received signal from the reception antenna RX. The beat signal is an interference signal that represents the frequency difference between the received signal and the local signal. The mixed received signal is acquired as a digitized time signal sampled at predetermined time intervals by an A/D converter.

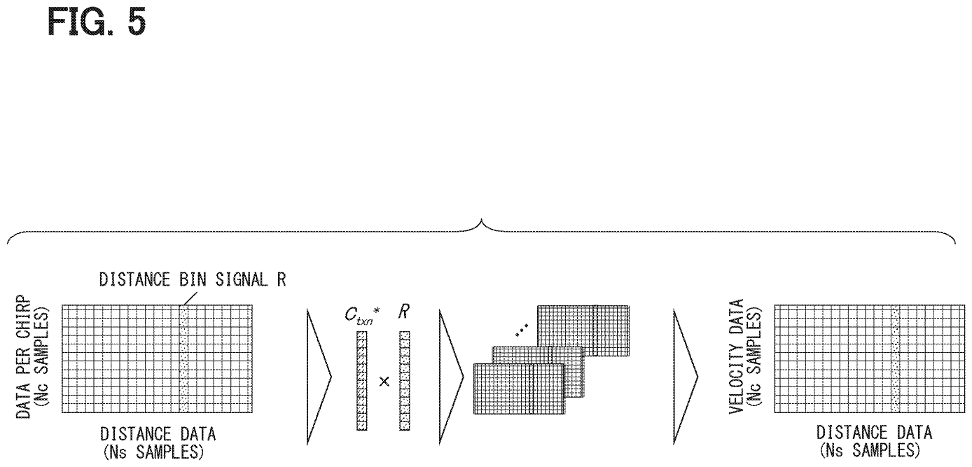

Subsequently, in S20, the definition block 120 performs a Fast Fourier Transform (FFT) on the mixed received signal. As a result, the definition block 120 obtains a distance spectrum of each chirp in the mixed received signal. The obtained distance spectrum is a frequency spectrum that exhibits peaks corresponding to the distance to the target, and is discrete distance data that includes signal intensity information for each bin (distance bin) corresponding to a distance, as distance information. Hereafter, as shown in FIG. 5, the Ns samples of each of the N_{c} chirps are converted into distance data by FFT processing, and the data obtained by extracting N_{c} samples for a specific distance bin is referred to as the distance bin signal R. Here, the received signal component originating from the transmitted signal from the transmission antenna TXn and encoded by the code Cₜₓₙ is denoted as Pₙ. The distance bin signal R before decoding can be defined by the following equation (1) as the sum of the received signal components CₜₓₙPₙ before decoding from each transmission antenna TX.

$$\begin{matrix}Equation 1 & \\ R = {\sum }_{k} {C}_{t x k} {P}_{k} & ( 1 )\end{matrix}$$

In S30, the definition block 120 defines a decoded signal corresponding to the distance bin signal R. Specifically, the definition block 120 generates, for each code corresponding to each transmission antenna TX, a decoded signal by decoding the distance bin signal R using that code. The definition block 120 stores each decoded signal for each code in the memory 101.

For example, suppose that the transmission antenna TX1 is the target transmission antenna. In this case, in S30, the definition block 120 performs decoding for those codes among the codes Cₜₓ₂ to Cₜₓ₁₂ corresponding to the other transmission antennas TX2 to TX12 that have not yet been decoded in the previous loops. For example, when decoding is to be performed for a specific code Cₜₓₙ, the decoded signal is represented by the following equation (2) using the code Cₜₓₙ* for decoding the phase modulation by Cₜₓₙ. Here, the code Cₜₓₙ* is a vector in which each element is the complex conjugate of the code Cₜₓₙ, for example, by multiplying it with Cₜₓₙ, all elements become 1.

$$\begin{matrix}Equation 2 & \\ R {C}_{t x n}^{*} = {\sum }_{k} {C}_{t x n}^{*} {C}_{t x k} {P}_{k} & ( 2 )\end{matrix}$$

In the subsequent S40, the definition block 120 performs a fast Fourier transform (FFT) on the decoded signal. As a result, the definition block 120 obtains the Doppler frequency spectrum of the mixed received signal. This frequency spectrum is a velocity spectrum that exhibits peaks corresponding to the speed of the target, and is discrete velocity data that includes signal intensity information for each bin (velocity bin) corresponding to speed. By means of this second FFT processing, the definition block 120 can obtain two-dimensional map data of distance and velocity, as shown in FIG. 5. This two-dimensional map data may also be referred to as an RV map. It should be noted that, in the fast Fourier transform processing, the definition block 120 multiplies a window function to the distance bin signal R. In this processing, window functions other than the rectangular function may include, for example, a Hanning function or a Gaussian function.

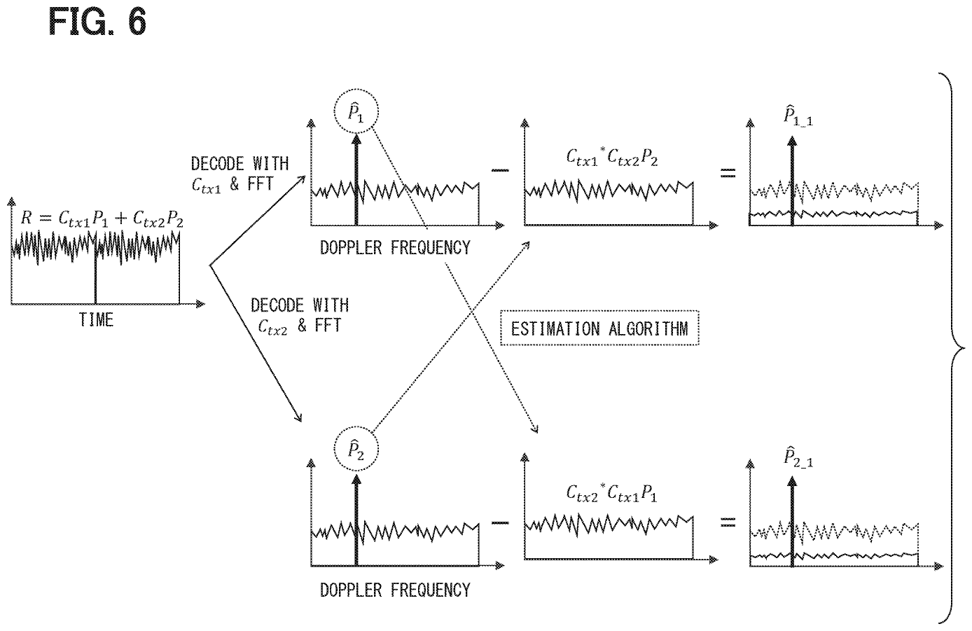

In the above equation (2), when k=n, a coefficient of Pₙ becomes 1. Therefore, as shown in FIG. 6, the velocity spectrum is a combination of the spectrum of the peak Pₙ and the diffused spectrum resulting from the other terms. The spectrum resulting from terms other than Pₙ corresponds to sidelobe signal components. In an example shown in FIG. 6, for the sake of simplicity, the distance bin signal R based on the received signals reflected from the target, in which the transmitted signals modulated by codes Cₜₓ₁ and Cₜₓ₂ are respectively sent from the two transmission antennas TX1 and TX2, is illustrated.

In the subsequent step S50, the suppression block 130 detects peaks from the frequency spectrum. For the peak detection, the suppression block 130 may, for example, identify the frequency bin where the intensity is at a maximum as a peak position. The suppression block 130 detects peaks by performing, for example, a CFAR (Constant False Alarm Rate) process. The suppression block 130 acquires at least the identified peak position and its peak intensity as peak information relating to the detected peak. The peak information may also include the phase or other data at the peak. In a case of the decoded signal RCₜₓₙ*, the peak detection corresponds to detecting Pₙ in equation (2). A peak in the frequency spectrum of the decoded signal is an example of a “target signal component,” which is a received signal component corresponding to the transmitted signal targeted in the decoded signal.

Then, in step S60, the suppression block 130 selects an algorithm for the sidelobe suppression processing. The suppression block 130 selects from among a plurality of algorithms previously stored in, for example, the memory 101, based on characteristic parameters correlated with the performance of each algorithm.

For example, the characteristic parameter is a parameter correlated with the computational load of each algorithm. The suppression block 130 acquires the computational load for each algorithm correlated with the characteristic parameter. The suppression block 130 selects the algorithm with the smallest computational load as the algorithm to be used for sidelobe suppression processing. In particular, in the present embodiment, the suppression block 130 selects an algorithm related to the estimation processing of the sidelobe signal component among the sidelobe suppression processes.

For example, the characteristic parameter is at least one of the following: the number of target peaks Nₚₖ, the target peak frequency fₚₖ, the number of chirps N_{c}, the code Cₜₓₙ, the CDM multiplexing number N_{cdm}, or the S/N ratio χ_{tgt}. The characteristic parameter is defined for each algorithm. For example, the characteristic parameters include those that are common to each algorithm.

Here, the number of target peaks Nₚₖ refers to the number of peaks in the decoded signal spectrum detected in S50, and the target peak frequency fₚₖ refers to the frequency of each of these peaks. The number of chirps N_{c} is the number of chirps per transmission cycle in the transmitted signal. The CDM multiplexing number N_{cdm} is the multiplexing number of the transmitted signal multiplexed by code Cₜₓₙ, i.e., the number of codes Cₜₓₙ used.

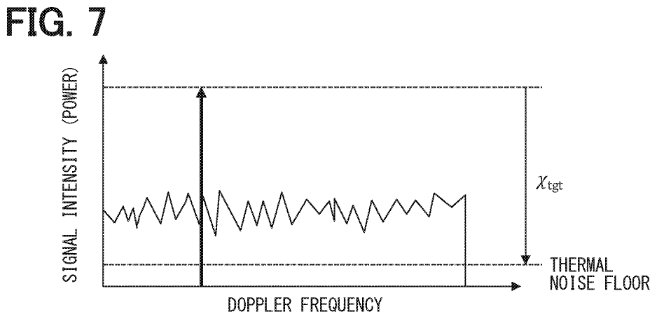

The S/N ratio χ_{tgt} is a ratio from the peak intensity in the decoded signal to the magnitude of the thermal noise floor, that is, the ratio of the peak intensity to the thermal noise floor in the decoded signal (see FIG. 7). The thermal noise may be thermal noise that is theoretically estimable as a parameter correlated with the circuit configuration and ambient temperature in the radar device 1. Alternatively, the thermal noise may be thermal noise as a parameter correlated with the received signal strength in regions of the RV map where no target is present. Note that the thermal noise as a parameter correlated with the received signal strength may be thermal noise corresponding to a mean value, a median value, or mode value of the received signal strength in the above-mentioned region.

The following explanation assumes a case in which the suppression block 130 can execute two algorithms, A1 and A2, regarding the algorithm selected by the suppression block 130.

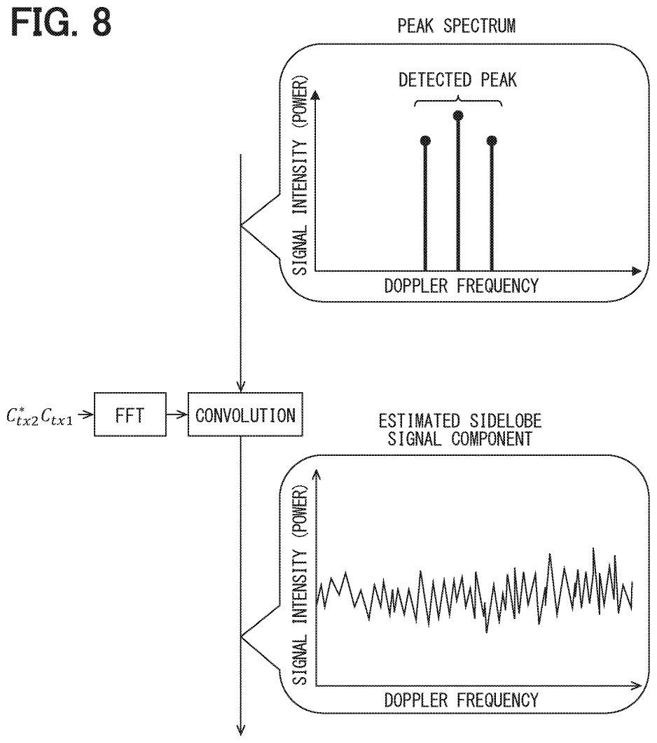

Algorithm A1 is an algorithm that estimates the sidelobe signal components by convolving the target peak with the Fourier-transformed code. Describing in detail with reference to FIG. 8, when executing this algorithm A1, the suppression block 130 generates a spectrum of the code component Cₜₓₙ*Cₜₓₖ by Fourier-transforming the code component Cₜₓₙ*Cₜₓₖ in the sidelobe signal components of the decoded signal spectrum. The suppression block 130 obtains the estimated spectrum of the sidelobe signal components by convolving the spectrum of the code component Cₜₓₙ*Cₜₓₖ with the peak spectrum corresponding to the target peak. The peak spectrum is a spectrum in which all signal intensities except for the peak in the decoded signal spectrum have been replaced with zero. FIG. 8 shows an example in which the spectrum of the Fourier-transformed code component Cₜₓ₂*Cₜₓ₁ is convolved with the peak spectrum of the decoded signal decoded for the code Cₜₓ₁. In this case, as shown in FIG. 8, the sidelobe signal components in the decoded signal spectra decoded for codes other than Cₜₓ₁ are estimated.

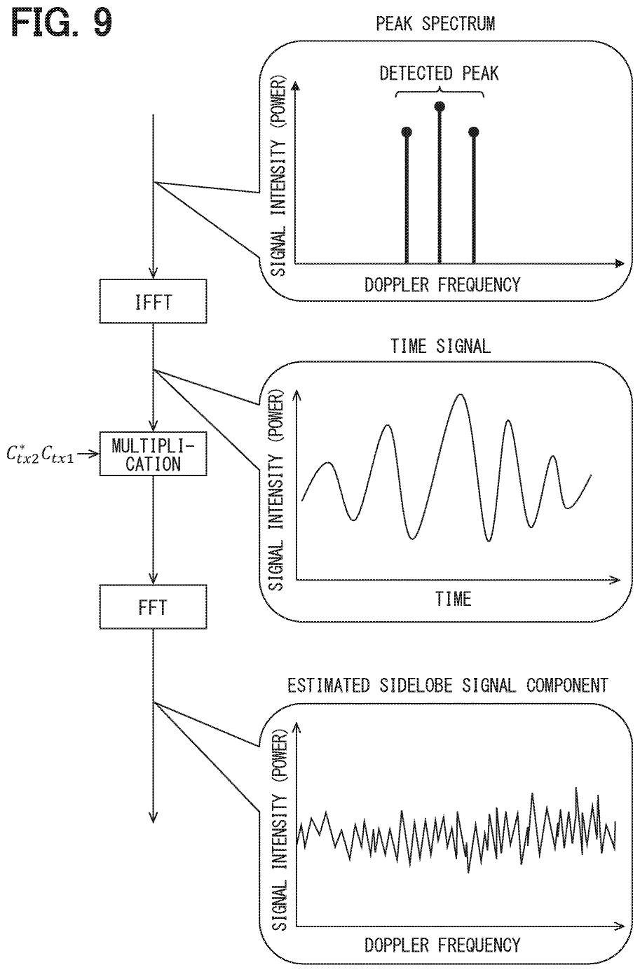

Algorithm A2 is an algorithm that estimates the sidelobe signal components by performing the Fourier transform on the result of multiplying the inverse Fourier transform of the target peak by the code component. Describing in detail according to FIG. 9, when executing this algorithm A2, the suppression block 130 performs the inverse Fourier transform process on the peak spectrum. As a result, the suppression block 130 obtains the time-domain signal of the peak component. The suppression block 130 multiplies the time-domain signal of the peak component by the code component Cₜₓₙ*Cₜₓₖ. The suppression block 130 obtains an estimated spectrum of the sidelobe signal components by performing the Fourier transform on the time-domain signal multiplied by the code component Cₜₓₙ*Cₜₓₖ. In FIG. 9, an example is shown in which the code component Cₜₓ₂*Cₜₓ₁ is multiplied by the time-domain signal of the peak spectrum in the decoded signal decoded for code Cₜₓ₁. Therefore, in FIG. 9, the sidelobe signal components in the decoded signal spectra decoded for codes other than code Cₜₓ₁ are estimated.

The suppression block 130 selects the algorithm with a lower computational load, f₁ or f₂, correlated with the characteristic parameter, from among the above algorithms A1 and A2. The computational loads f₁ and f₂ for each algorithm A1 and A2 are defined, for example, as values correlated with the number of data multiplications required to obtain the estimated spectrum of the sidelobe signal components from the peak spectrum. The computational load f₁ of algorithm A1 correlates with the CDM multiplexing number N_{cdm}, the number of target peaks Nₚₖ, and the number of chirps N_{c}, as characteristic parameters. More specifically, a relationship between the computational load f₁ and the above three characteristic parameters is represented by a following equation (3).

$$\begin{matrix}Equation 3 & \\ {f}_{1} = {N}_{C D M} {N}_{p k} {N}_{c} & ( 3 )\end{matrix}$$

On the other hand, the computational load f2 of algorithm A2 correlates with the CDM multiplexing number N_{cdm} and the number of chirps N_{c} as characteristic parameters. More specifically, the relationship between the computational load f2 and the above two characteristic parameters is represented by a following equation (4).

$$\begin{matrix}Equation 4 & \\ {f}_{2} = {N}_{C D M} {N}_{c} log {N}_{c} & ( 4 )\end{matrix}$$

The suppression block 130 determines which of algorithms A1 or A2 has the lower computational load f₁ or f₂, according to the above relationships. The suppression block 130 selects, as the algorithm to be actually executed in subsequent steps, the algorithm A1 or A2 that has the lower computational load f₁ or f₂.

In the subsequent step S70, the suppression block 130 performs the sidelobe suppression processing. More specifically, the suppression block 130 performs estimation processing of the sidelobe signal components using the selected algorithm A1 or A2. Then, the suppression block 130 performs a removal process to eliminate the estimated sidelobe signal components from the spectrum of the decoded signal. Through the sidelobe suppression processing, which includes the above estimation and removal processes, the suppression block 130 obtains a spectrum (suppressed spectrum) in which the sidelobe signal components have been suppressed from the decoded signal spectrum.

The suppression block 130 performs the sidelobe suppression processing for each of the plurality of decoded signals decoded by each code. For example, as shown in FIG. 6, assume that the sidelobe suppression processing is performed for the distance bin signal R, in which the transmitted signals modulated by codes Cₜₓ₁ and Cₜₓ₂, respectively, are reflected by the target. In this case, the suppression block 130 estimates the sidelobe signal components Cₜₓ₂*Cₜₓ₁P₁\hat{ } in the spectrum of the decoded signal RCₜₓ₂*, based on the detected peak spectrum P₁\hat{ } from the spectrum of the decoded signal RCₜₓ₁*. Then, the suppression block 130 removes this sidelobe signal components Cₜₓ₂*Cₜₓ₁P₁\hat{ } from the spectrum of the decoded signal RCₜₓ₂*. Similarly, the suppression block 130 estimates the sidelobe signal components Cₜₓ₁*Cₜₓ₂P₂\hat{ } in the spectrum of the decoded signal RCₜₓ₁*, based on the detected peak spectrum P₂\hat{ } from the spectrum of the decoded signal RCₜₓ₂*. Then, the suppression block 130 removes this sidelobe signal components Cₜₓ₁*Cₜₓ₂P₂\hat{ } from the spectrum of the decoded signal RCₜₓ₁*.

In FIG. 6, for the sake of simplicity, the sidelobe suppression processing is illustrated for a case where the transmitted signal is modulated using two types of codes. However, even when three or more types of codes are used in the modulation, the suppression block 130 can similarly perform the sidelobe suppression processing. For example, the same applies even when the transmitted signals of each of the twelve transmission antennas (TX) are modulated with different codes. In this case, the suppression block 130 estimates the sidelobe signal components from each peak in the twelve types of decoded signals, which have been decoded for each code, to the other decoded signals, and removes each sidelobe signal component from each decoded signal.

The suppression block 130 may also perform iterative sidelobe suppression processing. The iteration is a process in which, based on the peak spectrum extracted from the decoded signal spectrum after the sidelobe signal components have been suppressed, the sidelobe signal components in other decoded signal spectra are re-estimated, and these re-estimated sidelobe signal components are removed from the respective other decoded signal spectra. By performing the iteration for an appropriate number of times, the suppression block 130 can further suppress the sidelobe signal components.

Subsequently, in S80, the output block 140 acquires target information from the frequency spectrum. The target information includes at least one type among the target's distance, speed, and direction. When the target information includes a direction, the output block 140 estimates the direction, for example, by using a Direction of Arrival (DoA) method. The output block 140 may output the target information to an external in-vehicle ECU of the radar device 1. Alternatively, the output block 140 may output the target information to a center located outside the vehicle.

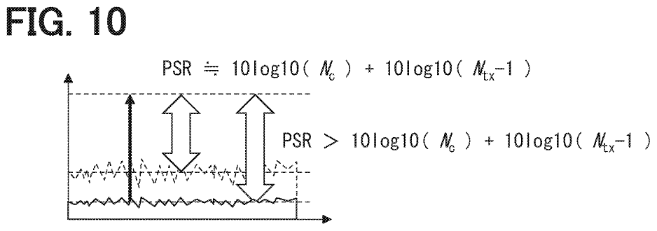

A difference in dynamic range PSR between a case where the above-mentioned sidelobe suppression is performed and a case where it is not performed will be explained with reference to FIG. 10. When a single target is assumed, the dynamic range PSR can be expressed as a ratio from the maximum value of the peak of the target to the sidelobe. When the removal processing is not performed, this dynamic range PSR satisfies the relationship shown in a following equation (5), which depends on the total number of chirps N_{c} in the transmitted signal and the number of transmission antennas Nₜₓ modulated by the CDM code.

$$\begin{matrix}Equation 5 & \\ PSR \approx 10 log 10 ( {N}_{c} ) + 10 log 10 ( {N}_{t x} - 1 ) & ( 5 )\end{matrix}$$

On the other hand, when the removal processing shown in the present embodiment is executed, the dynamic range PSR satisfies a relationship shown in the following equation (6).

$$\begin{matrix}Equation 6 & \\ P S R > 10 log 10 ( {N}_{c} ) + 10 log 10 ( {N}_{t x} - 1 ) & ( 6 )\end{matrix}$$

That is, in the radar device 1 that performs the sidelobe suppression, the dynamic range PSR becomes greater than in the radar device 1 that does not perform it.

According to the first embodiment described above, the algorithm followed by the estimation processing of the sidelobe signal components is selected in accordance with the characteristic parameters on which the performance of each algorithm depends. Since the characteristic parameters pertain to the decoded signal or related signals, the algorithm can be selected according to the reception conditions of the mixed received signal. Accordingly, it becomes possible to determine the algorithm followed by the sidelobe signal component suppression processing according to the situation.

### Second Embodiment

A second embodiment is a modification to the first embodiment.

In the second embodiment, a suppression block 130 estimates the sidelobe signal components based on a determinant established between a decoded signal spectrum and a true peak spectrum. For example, for the sake of simplicity, assuming that there are two transmission antennas, TX1 and TX2, decoded signals RCₜₓ₁* and RCₜₓ₂* are denoted as P1_{dec} and P2_{dec}, respectively. Also, let P₁ denote the true peak signal component resulting from the transmitted signal from transmission antenna TX1, and P₂ denote the true peak signal component resulting from the transmitted signal from transmission antenna TX2. In this case, the decoded signal spectra P_{1dec} and P_{2dec}, and the true peak spectra P₁ and P*, are represented by a determinant relationship shown in a following equation (7).

$$\begin{matrix}Equation 7 & \\ ( \begin{matrix}{P}_{1 d e c} \\ {P}_{2 d e c}\end{matrix} ) = ( \begin{matrix}1 & {C}_{12} \\ {C}_{21} & 1\end{matrix} ) ( \begin{matrix}{P}_{1} \\ {P}_{2}\end{matrix} ) & ( 7 )\end{matrix}$$

Note that in the matrix of a first term on a right side, C₁₂ denotes Cₜₓ₁*Cₜₓ₂, and C₂₁ denotes Cₜₓ₂*Cₜₓ₁. Here, let the matrix on a left side of equation (7), which represents the decoded signal spectra, be denoted as P, the matrix representing the first term on the right side be denoted as C+I (where “I” is the identity matrix), and the matrix representing the true peak spectra in the second term on the right side be denoted as Pₜ. In this case, equation (7) can be replaced by a following equation (8).

$$\begin{matrix}Equation 8 & \\ P = ( C + I ) {P}_{t} = C {P}_{t} + {P}_{t} & ( 8 )\end{matrix}$$

In the above equation (8), the sidelobe signal component is CPt, which is the first term on the right side. Therefore, since the matrix (C+I) is known from the code and the target peak frequency fₚₖ, estimating Pₜ also makes it possible to estimate the sidelobe signal components. Here, equation (8) can be transformed into a following equation (9).

$$\begin{matrix}Equation 9 & \\ {P}_{t} = {( C + I )}^{- 1} P & ( 9 )\end{matrix}$$

That is, the suppression block 130 can estimate the sidelobe signal components by solving equation (9) for Pₜ and multiplying Pₜ by C.

In S60 of the present embodiment, the suppression block 130 selects the Pₜ solving algorithm from among multiple algorithms. For example, the suppression block 130 selects the solving algorithm from among three algorithms. One of the solving algorithms is the Jacobi method. Another solving algorithm is the Gauss-Seidel method. A further solving algorithm is a method that multiplies the inverse matrix or pseudo-inverse matrix of (C+I) by P.

The suppression block 130 selects, as the solving algorithm, an algorithm in which Pₜ converges. In other words, the suppression block 130 selects an algorithm in which the computational load of Pₜ does not become infinite. Whether Pₜ converges is determined by the properties of the matrix (C+I). Since the matrix (C+I) is determined according to the code and the peak frequency as described above, in the present embodiment, the code and the peak frequency serve as characteristic parameters. More specifically, the suppression block 130 selects an algorithm based on the absolute values of the maximum eigenvalue λ₁ₘₐₓ of matrix C and the maximum eigenvalue λ₂ₘₐₓ of matrix (I+C_{L})⁻¹C_{U}. Note that matrix C_{L} is a lower triangular matrix of matrix C, and matrix C_{U} is an upper triangular matrix of matrix C.

### OTHER EMBODIMENTS

As described above, several embodiments have been explained, but the present disclosure is not to be construed as being limited to these embodiments, and can be applied to various embodiments and combinations thereof without departing from the spirit of the disclosure.

In a modification, the suppression block 130 may remove the sidelobe signal component from the distance bin signal instead of from the decoded signal. In this case, the distance bin signal is an example of a “related signal” associated with the decoded signal.

In a modification, the transmitted signal generation unit 2 may apply modulation with different codes for each antenna set including the transmission antennas TX. In this case, different codes are applied to the transmitted signals for each of the antenna sets, each including a predetermined number of transmission antennas TX. In this case, the control unit 100 performs the removal process for each code of each antenna set. In addition, the transmitted signals corresponding to each transmission antenna TX within the antenna set are subjected to phase shift modulation or amplitude modulation, making it possible to separate the corresponding received signal components for each transmitted signal.

In a modification, the output block 140 of S80 may output the frequency spectrum to the outside as the target information. For example, the output block 140 outputs the frequency spectrum to an external in-vehicle ECU outside the radar device 1. In this case, the position and other information of the target are obtained from the peaks of the target contained in the frequency spectrum by the destination in-vehicle ECU.

In a modification, the radar device 1 may be provided with only a single transmission antenna TX. In this case, the transmitted signal generation unit 2 generates a transmitted signal in which multiple transmitted signals, each modulated by a different code, are mixed for the single transmission antenna.

In a modification, the suppression block 130 may select the algorithm based only on characteristic parameters that are not common to each algorithm.

In a modification, the dedicated computer constituting the control unit 100 may be an integrated ECU that integrates driving control of the vehicle. The dedicated computer configuring the control unit 100 may be a determination ECU that determines driving tasks in the driving control of the vehicle. The dedicated computer constituting the control unit 100 may be a monitoring ECU that monitors the driving control of the vehicle. The dedicated computer constituting the control unit 100 may be an evaluation ECU that evaluates the driving control of the vehicle.

In a modification, the dedicated computer of the control unit 100 may be a navigation ECU that navigates a travel route of the vehicle. The dedicated computer constituting the control unit 100 may be a locator ECU that estimates a self-state quantity of the vehicle. The dedicated computer that constitutes the control unit 100 may be an actuator ECU that individually controls the travel actuators of the vehicle. The dedicated computer constituting the control unit 100 may be a human machine interface (HMI) control unit (HCU) that controls information presentation in the vehicle. The dedicated computer that configures the control unit 100 may be a computer other than the vehicle, which configures an external center or a mobile terminal that can communicate with the vehicle, for example.

In a modification, the dedicated computer constituting the control unit 100 may include at least one of a digital circuit and an analog circuit as a processor. Here, the digital circuit refers to at least one type among, for example, an ASIC (Application Specific Integrated Circuit), FPGA (Field Programmable Gate Array), SoC (System on a Chip), PGA (Programmable Gate Array), and CPLD (Complex Programmable Logic Device). Such digital circuits may also include a memory for storing programs.

In a modification, the moving object to which the control unit 100 is applied may be, for example, an autonomous robot capable of transporting luggage or collecting information by autonomous driving or remote driving. Furthermore, as the autonomous device (autonomous robot), it may be an autonomous mobile robot including an autonomous vehicle.

The embodiments and modifications described above may be implemented as a control unit that is configured to be mountable on a mobile body and has at least one processor 102 and at least one memory 101. Specifically, the above-described embodiment and modified examples may be implemented in the form of a processing circuit (e.g., a processing ECU) or a semiconductor device (e.g., a semiconductor chip).

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radar device comprising:
a transmission antenna;
a reception antenna; and
at least one of (i) a circuit and (ii) a processor having a memory storing computer program code executable by the processor, wherein
the at least one of the circuit and the processor is configured to generate types of transmitted signals, modulated by respective codes, for transmission from the transmission antenna,
the reception antenna is configured to receive a mixed received signal in which the transmitted signals, after being reflected by a reflector, are mixed,
the at least one of the circuit and the processor is configured to:
acquire the mixed received signal received by a specific reception antenna;
generate decoded signals, corresponding to the respective codes for each transmitted signal, by decoding the mixed received signal;
select an algorithm to be used for a suppression process from algorithms in accordance with a characteristic parameter correlated with performance of each of the algorithms; and
perform, in accordance with the selected algorithm, the suppression process that suppresses, in another decoded signal or in a related signal associated with the decoded signals, a sidelobe signal component, which is detected in another decoded signal, in correlation with a target signal component, the target signal component being a received signal component corresponding to a transmitted signal targeted in a specific decoded signal.

2. The radar device according to claim 1, wherein
the at least one of the circuit and the processor is configured to execute, in the suppression process, an estimation process for estimating the sidelobe signal component and a removal process for subtracting the estimated sidelobe signal component from another decoded signal or the related signal, and to select the algorithm for the estimation process in accordance with the characteristic parameter.

3. The radar device according to claim 1, wherein
the at least one of the circuit and the processor is configured to select the algorithm to be used for the suppression process in accordance with a characteristic parameter common among candidate algorithms to be selected.

4. The radar device according to claim 1, wherein
the characteristic parameter includes a value correlated with a computational load of each of the algorithms.

5. The radar device according to claim 4, wherein
the characteristic parameter includes a number of peaks related to the reflector in a frequency spectrum of the decoded signals.

6. The radar device according to claim 4, wherein
the characteristic parameter includes a frequency of a peak related to the reflector in a frequency spectrum of the decoded signals.

7. The radar device according to claim 4, wherein
the characteristic parameter includes a number of types of the respective codes.

8. The radar device according to claim 4, wherein
the characteristic parameter includes a ratio of a peak related to the reflector to thermal noise in a frequency spectrum of the decoded signals.

9. A radar control method for controlling a radar device comprising a transmission antenna, a reception antenna, and at least one of (i) a circuit and (ii) a processor having a memory storing computer program code executable by the processor, the method comprising:
generating types of transmitted signals, modulated by respective codes, for transmission from the transmission antenna;
receiving, by the reception antenna, a mixed received signal in which the transmitted signals, after being reflected by a reflector, are included;
acquiring the mixed received signal received by a specific reception antenna;
generating decoded signals, corresponding to the respective codes for each transmitted signal, by decoding the mixed received signal;
selecting an algorithm to be used for a suppression process from algorithms in accordance with a characteristic parameter correlated with performance of each of the algorithms; and
performing, in accordance with the selected algorithm, the suppression process that suppresses, in another decoded signal or in a related signal associated with the decoded signals, a sidelobe signal component, which is detected in another decoded signal, in correlation with a target signal component, the target signal component being a received signal component corresponding to a transmitted signal targeted in a specific decoded signal.

10. A non-transitory computer-readable storage medium storing a computer program comprising instructions that, when executed by a processor, cause the processor to control a radar device comprising a transmission antenna and a reception antenna, the instructions causing the processor to:
generate types of transmitted signals, modulated by respective codes, for transmission from the transmission antenna;
receive, by the reception antenna, a mixed received signal in which the transmitted signals reflected by a reflector are included;
acquire the mixed received signal received by a specific reception antenna;
generate decoded signals, corresponding to the respective codes for each transmitted signal, by decoding the mixed received signal;
select an algorithm to be used for a suppression process from algorithms in accordance with a characteristic parameter correlated with performance of each of the algorithms; and
perform, in accordance with the selected algorithm, the suppression process that suppresses, in another decoded signal or in a related signal associated with the decoded signals, a sidelobe signal component, which is detected in another decoded signal, in correlation with a target signal component, the target signal component being a received signal component corresponding to a transmitted signal targeted in a specific decoded signal.
